(19) United States
(12) Patent Application Publication
(10) Pub. No.: US 2011/0147636 A1
(43) Pub. Date: Jun. 23, 2011

(54) CONSTANT RESIDUAL PRESSURE VALVE

(75) Inventor: Shinobu OIKAWA, Kariya-city (JP)

(73) Assignee: DENSO CORPORATION, Kariya-city (JP)

(21) Appl. No.: 12/974,367

(22) Filed: Dec. 21, 2010

(30) Foreign Application Priority Data
Dec. 21, 2009 (JP) 2009-288635
Jun. 29, 2010 (JP) 2010-147599

(51) Int. Cl. F16K 27/02

(52) U.S. Cl. 251/336

(57) ABSTRACT

A constant residual pressure valve is provided with a valve body, a valve seat, a communication passage, and an orifice upstream of the valve seat. A cylindrical passage is arranged between the orifice and the valve seat in such a manner as to introduce cavitation bubbles toward the valve seat. The cavitation bubbles are generated in the fuel discharged from the orifice. When the cavitation babbles are collapsed, the foreign matters accumulated on the third valve seat 63 and the valve body 69 are removed.

### CROSS-REFERENCE TO RELATED APPLICATION

This application is based on Japanese Patent Applications No. 2009-288635 filed on Dec. 21, 2009, and No. 2010-147599 filed on Jun. 29, 2010, the disclosures of which are incorporated herein by reference.

### FIELD OF THE INVENTION

The present invention relates to a constant residual pressure valve which is applied to a fuel supply system of a direct injection engine.

### BACKGROUND OF THE INVENTION

Conventionally, a fuel supply system which supplies fuel to a direct injection engine is equipped with a high-pressure pump. Fuel discharged from the high-pressure pump is accumulated in a delivery pipe and is injected to a cylinder through an injector.

JP-2009-121395A (WO-2009/063306A1) shows a constant residual pressure valve which is provided to a fuel passage connecting a pressurization chamber of a high-pressure pump and a delivery pipe. When a differential fuel pressure between the delivery pipe and the pressurization chamber exceeds a specified value, the constant residual pressure valve is opened to allow a fuel flow from the delivery pipe to the pressurization chamber.

This constant residual pressure valve has a valve body, a valve seat, and an orifice which determines a fuel flow rate flowing from the delivery pipe to the pressurization chamber. An outlet opening of the orifice is directly connected to the valve seat. The fuel discharged from the delivery pipe flows through the orifice and a clearance between the valve body and the valve seat. Since the clearance between the valve body and the valve seat is very small, it is likely that foreign matters contained in the fuel are accumulated in the clearance. Such foreign matters may deteriorate a valve performance and the high-pressure pump performance.

However, the constant residual pressure valve described in the above patent document has no function to remove the accumulated foreign matters. Thus, it is likely that a sealing performance between the valve body and the valve seat is deteriorated and a pressure holding performance of the constant residual pressure valve is also deteriorated.

If the pressure holding performance of the constant residual pressure valve is deteriorated and the fuel pressure in the delivery pipe falls after the engine is stopped, an evaporation temperature of fuel will also fall. Further, the fuel temperature in the delivery pipe rises due to temperature rise in the engine room. If the fuel temperature in the delivery pipe exceeds an evaporation temperature, vapors may be generated in the delivery pipe. Such vapors deteriorate a high-pressure pump characteristic and engine startability.

If the valve body adheres to the valve seat by the foreign matters, the constant residual pressure valve is continuously closed, whereby the delivery pipe receives heat from an engine room when the engine is stopped. The fuel temperature rise in the delivery pipe causes an increase in fuel pressure, so that the fuel pressure in the fuel injector may not be controlled under a fuel leak preventing pressure.

### SUMMARY OF THE INVENTION

The present invention is made in view of the above matters, and it is an object of the present invention to provide a constant residual pressure valve capable of maintaining a pressure holding performance.

A constant residual pressure valve controls a fuel flow between a high-pressure passage and a low-pressure passage. The constant residual pressure valve has a valve body, an orifice and a cylindrical passage. The valve body opens/closes a communication passage in cooperation with a valve seat which is formed on an inner surface of the communication passage. The communication passage hydraulically connects the high-pressure passage and the low-pressure passage. The orifice is arranged upstream of the valve seat. The cylindrical passage is arranged between the orifice and the valve seat in such a manner as to introduce cavitation bubbles toward the valve seat. The cavitation bubbles are generated in the fuel discharged from the orifice. The orifice has a specified flow passage area so that a pressure in a delivery pipe is increased by a high-pressure pump without any influence.

The cavitation babbles flow through the cylindrical fuel passage toward the valve seat and the valve body. When these babbles are collapsed, the foreign matters accumulated on the valve seat and the valve body are removed by babble collapsing impact. Thereby, a sealing performance between the valve body and the valve seat can be improved and a pressure holding performance of the constant residual pressure valve can be maintained.

### BRIEF DESCRIPTION OF THE DRAWINGS

Other objects, features and advantages of the present invention will become more apparent from the following description made with reference to the accompanying drawings, in which like parts are designated by like reference numbers and in which:

FIG. 1 is a partial cross-sectional view showing a constant residual pressure valve in which cavitation babbles are generated, according to a first embodiment;

FIG. 2 is a schematic diagram showing a fuel supply system to which the constant residual pressure valve is applied, according to the first embodiment;

FIG. 3 is a cross-sectional view showing a high-pressure pump provided with the constant residual pressure valve according to the first embodiment;

FIG. 4 is a partial cross-sectional view viewed along a direction IV in FIG. 3;

FIG. 5 is an enlarged cross-sectional view showing an essential portion in FIG. 4;

FIG. 6 is a characteristic chart showing a relationship between a position and a pressure of an orifice according to the first embodiment;

FIG. 7 is a time chart for explaining a characteristic when a constant residual pressure valve is applied to an engine, according to the first embodiment;

FIG. 8 is another time chart for explaining a characteristic when a constant residual pressure valve is applied to an engine, according to the first embodiment;

FIG. 9 is a plain view showing an orifice of a constant residual pressure valve according to a second embodiment;

FIG. 10 is a cross-sectional view taken along a line X-X in FIG. 9;

FIG. 11 is a cross-sectional view taken along a line XI-XI in FIG. 9;

FIG. 12 is a partial cross-sectional view showing a constant residual pressure valve in which cavitation babbles are generated, according to a second embodiment;

FIG. 13 is a plain view showing an orifice of a constant residual pressure valve according to a third embodiment;

FIG. 14 is a cross-sectional view taken along a line XIV-XIV in FIG. 13;

FIG. 15 is a cross-sectional view taken along a line XV-XV in FIG. 13;

FIG. 16 is a cross-sectional view showing a constant residual pressure valve according to a fourth embodiment;

FIG. 17 is a cross-sectional view showing a constant residual pressure valve according to a fifth embodiment;

FIG. 18 is a view in a direction of an arrow XVIII in FIG. 17;

FIG. 19 is an enlarged view of part XIX in FIG. 17;

FIG. 20 is a cross-sectional view showing a constant residual pressure valve according to a sixth embodiment;

FIG. 21 is an enlarged view of part XXI in FIG. 20;

FIG. 22 is a cross-sectional view showing a constant residual pressure valve according to a seventh embodiment;

FIG. 23 is a cross-sectional view showing a constant residual pressure valve according to an eighth embodiment;

FIG. 24 is a cross-sectional view showing a constant residual pressure valve according to a ninth embodiment;

FIG. 25 is a schematic diagram showing a fuel supply system to which the constant residual pressure valve is applied, according to a tenth first embodiment;

FIG. 26 is a cross-sectional view showing a constant residual pressure valve according to the tenth embodiment;

FIG. 27 is a schematic diagram showing a fuel supply system to which the constant residual pressure valve is applied, according to an eleventh embodiment;

FIG. 28 is a cross-sectional view showing a constant residual pressure valve according to a twelfth embodiment; and

FIG. 29 is a cross-sectional view taken along a line XXIX-XXIX in FIG. 28.

### DETAILED DESCRIPTION OF EMBODIMENTS

Hereafter, embodiments of the present invention will be described hereinafter.

### First Embodiment

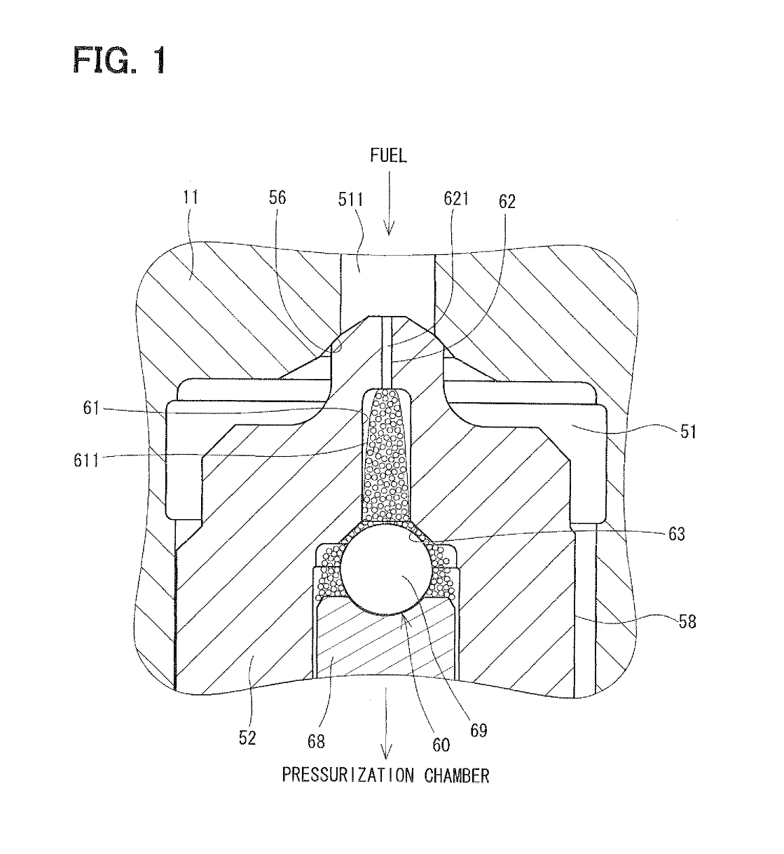

Referring to FIGS. 1 to 6, a first embodiment of the invention will be described.

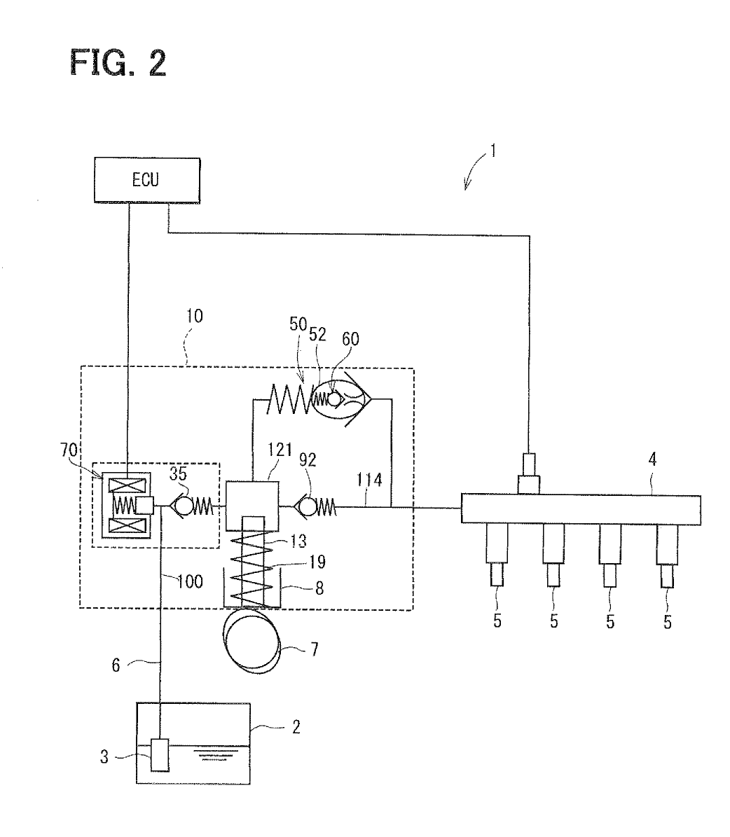

As shown in FIG. 2, a constant residual pressure valve is provided to a high-pressure pump 10. The high-pressure pump 10 is provided in a fuel supply system 1 of a direct injection engine. A low-pressure pump 3 pumps up fuel from a fuel tank 2. The high-pressure pump 10 pressurizes the fuel and feeds the fuel to a delivery pipe 4. The high pressure fuel accumulated in the delivery pipe 4 is injected into each cylinder through a fuel injector 5.

A basic configuration and an operation of the high-pressure pump 10 will be described hereinafter.

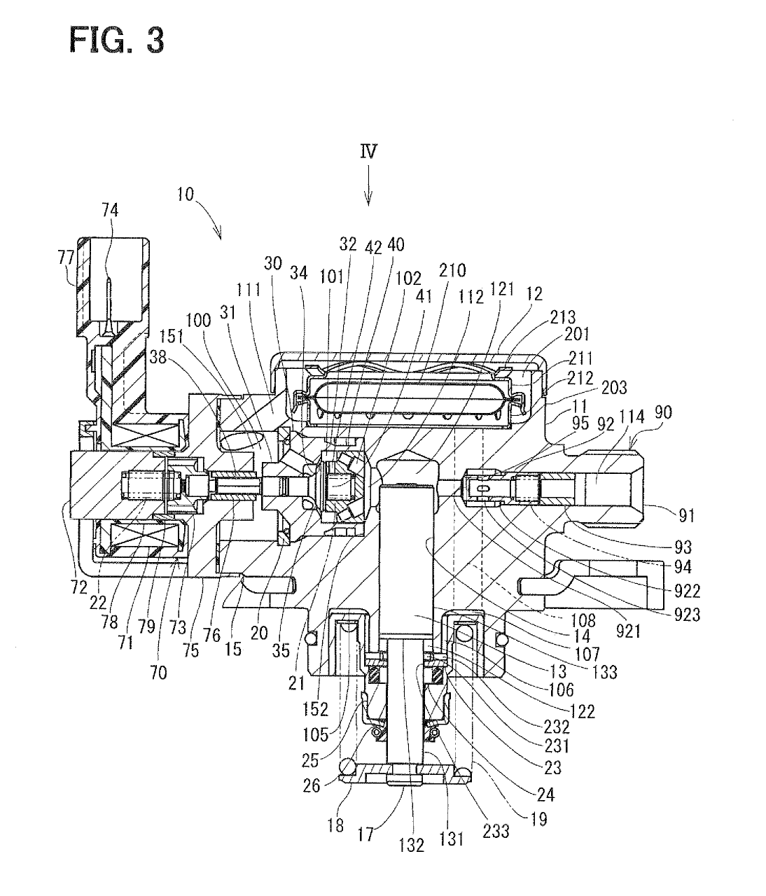

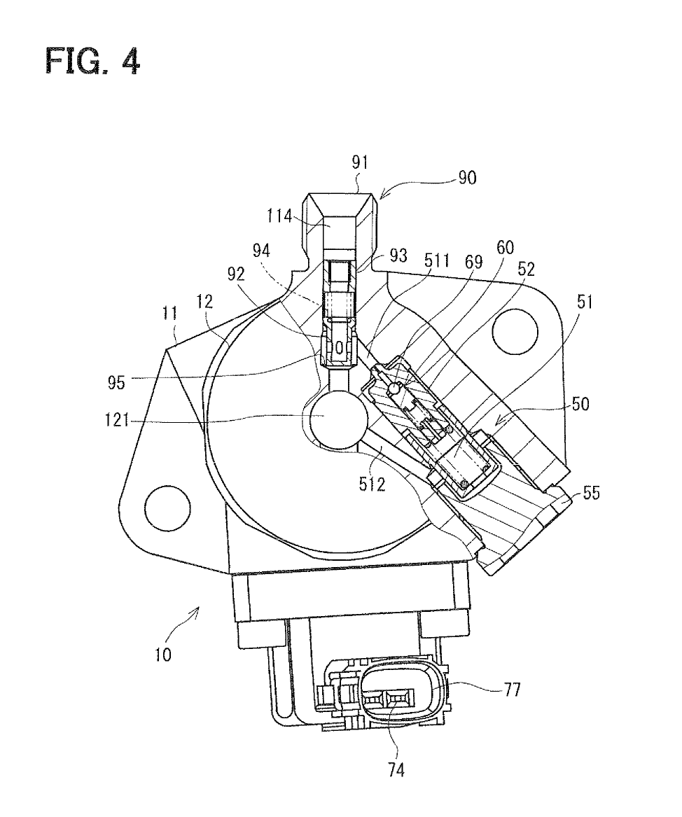

As shown in FIGS. 3 and 4, the high pressure pump 10 is provided with a pump body 11, a plunger 13, a valve body 30, a solenoid driving portion 70, a discharge valve portion 90, and a pressure adjusting portion 50. The pump body 11 forms a cylinder 14 therein. A plunger 13 is accommodated in the cylinder 14. A pressurization chamber 121 is defined by the plunger 13 and the cylinder 14.

The pump body 11 defines a damper chamber 201 which is surrounded by a cylindrical portion 203. The damper chamber 201 accommodates a metallic diaphragm damper 210, a first supporting member 211, a second supporting member 212, and an elastic member 213. A lid member 12 is provided on the damper chamber 201.

The damper chamber 201 communicates with a fuel inlet (not shown) through a fuel passage (not shown). This fuel inlet communicates with the fuel tank 2 through a low-pressure fuel pipe 6 (refer to FIG. 2). The fuel in the fuel tank 2 is introduced into the damper chamber 201. The pump body 11 has a cylindrical body portion 15 which extends perpendicularly relative to a center line of the cylinder 14. The cylindrical body portion 15 defines a passage 151 and a valve accommodating space 152 therein. A valve body 30 is accommodated in the valve accommodating space 152.

An introducing passage 111 hydraulically connects the damper chamber 201 and the passage 151. A suction passage 112 communicates with the pressurization chamber 121 and the valve accommodating space 152. The introducing passage 111 and the suction passage 112 communicate with each other through a passage defined in the valve body 30. A supply passage 100 is comprised of a fuel passage between the fuel inlet and the damper chamber 201, the damper chamber 201, the introducing passage 111, the suction passage 112, and a passage defined in the valve body 30.

The plunger 13 and its vicinity portion will be described hereinafter.

The plunger 13 is accommodated in the cylinder 14 in such a manner as to reciprocate in its axial direction. The plunger 13 has a small-diameter portion 131 and a large-diameter portion 133. A stepped surface 132 is formed between the small-diameter portion 131 and the large-diameter portion 133. An annular plunger stopper 23 is provided to the stepped surface 132.

The plunger stopper 23 has a concave portion 231 and grooves 232 which radially extend from the concave portion 231. An inner diameter of the concave portion 231 is larger than an outer diameter of the large-diameter portion 133. The plunger stopper 23 has a through hole 233 at its center. The small-diameter portion 131 of the plunger 13 is in the through hole 233. One end of the plunger stopper 23 abuts on the pump body 11. A variable volume chamber 122 is defined by the stepped surface 132, the outer wall surface of the small-diameter portion 131, an inner wall surface of the cylinder 14, the concave portion 231 and an annular space surrounded by the seal member 24.

The pump body 11 has an annular concave portion 105. An oil-seal holder 25 is inserted into the annular concave portion 105. The oil-seal holder 25 is fixed on the pump body 11 through the seal member 24. The seal member 24 regulates the thickness of the fuel around the small-diameter portion 131 to avoid a fuel leakage. An oil seal 26 is provided to the oil-seal holder 25. The oil seal 26 regulates the thickness of the oil around the small-diameter portion 131 to avoid an oil leakage.

Annular passages 106 and 107 are defined between the oil-seal holder 25 and the pump body 11. The passage 106 communicates with the grooves 232. The passage 106 and the passage 107 communicate with each other. The pump body 11 has a return passage 108 which hydraulically connects the passage 107 and the damper chamber 201. As above, the grooves 232, the passage 106, the passage 107, and the return passage 18 communicate with each other, whereby the variable volume chamber 122 communicates with the damper chamber 201.

The small-diameter portion 131 of the plunger 13 has a head 17 with which a spring seat 18 is engaged. A spring 19 is provided between the spring seat 18 and the oil-seal holder 25. The spring seat 18 is biased toward a cam 7 (shown in FIG. 2) by the spring 19. The plunger 13 is reciprocated by being contacted with the cam 7 through a tappet 8. One end of the spring 19 is engaged with the oil-seal holder 25 and the other end is engaged with the spring seat 18. The spring 19 biases the tappet 8 toward the cam 7 through the spring seat 18.

The volume of the variable volume chamber 122 is varied according to the reciprocation of the plunger 13. When the plunger 13 slides up in a metering stroke and a pressurization stroke, the volume of the pressurization chamber 121 is decreased and the volume of the variable volume chamber 122 is increased. A ratio of cross sectional area between the large-diameter portion 133 and the variable volume chamber 122 is about 1:0.6. Thus, in a case that the decreased volume of the pressurization chamber 12 is represented by “100”, the increased volume of the variable volume chamber 75 is represented by “60”. Therefore, about 60% of the fuel discharged into the damper chamber 201 from the pressurization chamber 121 is suctioned into the variable volume chamber 122 through the return passage 108, the passage 107, the passage 106 and the grooves 232. Thereby, the transfer of the pulsation is reduced about 60%.

Meanwhile, when the plunger 13 slides down in a suction stroke, the volume of the pressurization chamber 121 is increased and the volume of the variable volume chamber 122 is decreased. The fuel is introduced into the pressurization chamber 121 from the damper chamber 201, and the fuel in the variable volume chamber 122 is discharged into the damper chamber 201. About 60% of the fuel suctioned into the pressurization chamber 121 is supplied from the variable volume chamber 122, and about 40% of the fuel is suctioned from the fuel inlet. Thus, a suction efficiency of the fuel to the pressurization chamber 121 is improved.

Then, the discharge valve portion 90 will be described hereinafter.

The pump body 11 defines a discharge passage 114 which extends perpendicularly relative to the center axis of the cylinder 14. The discharge passage 114 communicates the pressurization chamber 121 and a fuel outlet 91. The discharge valve portion 90 allows or prohibits a discharge of fuel pressurized in the pressurization chamber 121. The discharge valve portion 90 is comprised of a discharge valve 92, a regulation member 93, a spring 94 and the like. The discharge valve 92 has a bottom portion 921 and a cylindrical portion 922. The discharge valve 92 is slidably disposed in the discharge passage 114. The regulation member 93 is cylindrically shaped and is fixed on an inner wall surface of the pump body 11. One end of the spring 94 is engaged with the regulation member 93 and the other end is engaged with the cylindrical portion 922.

The discharge valve 92 is biased toward a second valve seat 95 by the spring 94. When the discharge valve 92 sits on the second valve seat 95, the discharge passage 114 is closed. When the discharge valve 92 moves away from the second valve seat 95, the discharge passage 114 is opened. The regulation member 93 functions as a stopper of the discharge valve 92.

When the fuel pressure in the pressurization chamber 121 exceeds a specified value, the discharge valve 92 moves away from the second valve seat 95 against the biasing force of the spring 94. The fuel in the pressurization chamber 121 is discharged outside of the high-pressure pump 10 from the fuel outlet 91 through apertures 923.

When the fuel pressure in the pressurization chamber 121 becomes lower than the specified value, the discharge valve 92 sits on the second valve seat 95. Thereby, a reverse flow of the fuel toward the pressurization chamber 121 is avoided.

A suction valve portion including the valve body 30 and the suction valve 35 will be described hereinafter.

The valve body 30 is fixed inside of the passage 151 by an engaging member 20. The valve body 30 has a small-diameter portion 31 and a cylindrical portion 32. The cylindrical portion 32 defines a first valve seat 34. The suction valve 35 is disposed inside of the cylindrical portion 32. The suction valve 35 has a concave tapered surface which sits on the first valve seat 34.

A stopper 40 is provided to an inner wall surface of the cylindrical portion 32 to restrict a movement of the suction valve 35. A spring 21 is disposed between the stopper 40 and the suction valve 35 to bias the suction valve 34 toward the first valve seat 35.

Between an inner wall of the cylindrical portion 32 and an outer wall of the stopper 40, an annular fuel passage 101 is defined, which forms the supply passage 100. When the suction valve 35 is opened, the passage 151 communicates with the annular fuel passage 101. When the suction valve 35 is closed, the passage 151 is interrupted from the annular fuel passage 101.

The stopper 40 has a plurality of passages 102 which hydraulically connect the annular fuel passage 101 and the suction passage 112. A volume chamber 41 is defined inside of the stopper 40. Further, the stopper 40 has a passage 42 which hydraulically connects the volume chamber 41 and the annular fuel passage 101. Thus, the fuel in the passage 102 can flow into the volume chamber 41 through the passage 42.

The supply passage 100 includes the annular fuel passage 101 and the passage 102. The damper chamber 201 and the pressurization chamber 121 are hydraulically connected through the supply passage 100. That is, the fuel flows from the damper chamber 201 to the pressurization chamber 121 through the introducing passage 111, the passage 151, the annular fuel passage 101, the passage 102, and the suction passage 112. Also, the fuel flows from the pressurization chamber 121 to the damper chamber 201 through these passages.

Next, the solenoid driving portion 70 will be described hereinafter.

The solenoid driving portion 70 is comprised of a coil 71, a fixed core 72, a movable core 73, and a flange 75. The coil 71 is winded around a spool 78. When energized through a terminal 74 of a connector 77, the coil 71 generates a magnetic field. The fixed core 72 is made of magnetic material and is accommodated inside of the coil 71. The movable core 73 is made of magnetic material and confronts to the fixed core 72. The movable core 73 is slidably arranged in a cylindrical member 79 and the flange 75.

The cylindrical member 79 is made of nonmagnetic material and prevents a magnetic short circuit between the fixed core 72 and the flange 75. The flange 75 is made of magnetic material and is attached to the cylindrical body portion 15 of the pump body 11, whereby the solenoid driving portion 70 is fixed to the pump body 11. The flange 75 is provided with a guide cylinder 76. A needle 38 is slidably arranged in the guide cylinder 76. One end of the needle 38 is connected to the movable core 73 and the other end is engaged with the suction valve 35.

A spring 22 is provided between the fixed core 72 and the movable core 73. The spring 22 biases the movable core 73 to open the suction valve 35. When the coil is deenergized, the movable core 73 and the fixed core 72 are apart from each other. The spring 22 biases the needle 38 toward the suction valve 35 so that the needle 38 pushes the suction valve 35 to be opened.

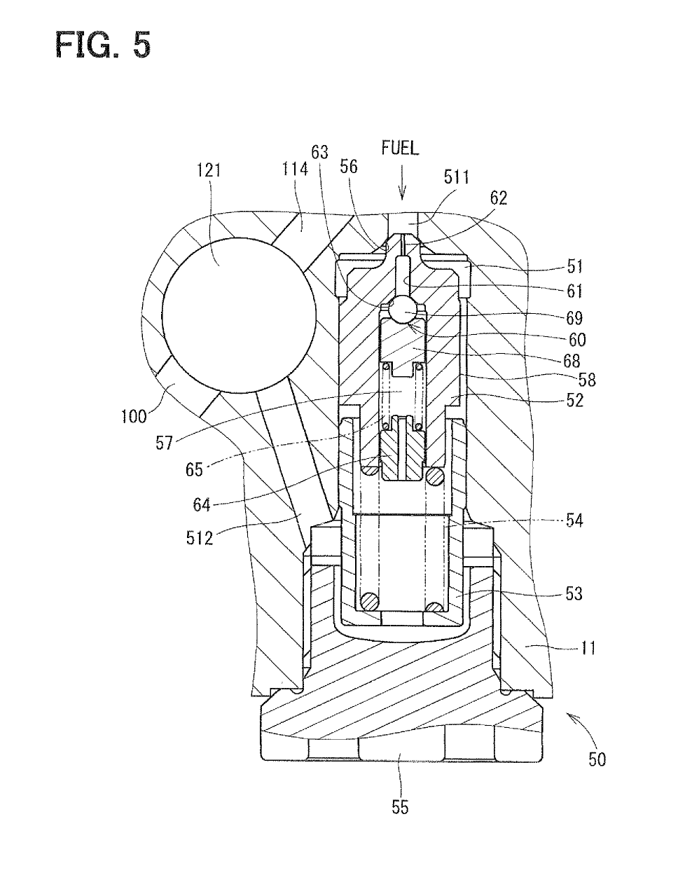

Referring to FIG. 5, the pressure adjusting portion 50 will be described hereinafter.

The pump body 11 has a communication passage 51 which extends perpendicularly relative to the center axis of the cylinder 14. The communication passage 51 is comprised of a first communication passage 511 and a second communication passage 512. A plug 55 closes an opening of the communication passage 51 at an outside wall of the pump body 11. The communication passage 51 hydraulically connects the discharge passage 114 and the pressurization chamber 121. The pressure adjusting portion 50 is comprised of a relief valve 52, an adjustment pipe 53, a spring 54, and a constant residual pressure valve 60.

The relief valve 52 is formed cylindrical and is slidably arranged in the communication passage 51. The relief valve 52 accommodates a valve body 69 of the constant residual pressure valve 60, a supporting member 68, a spring 65, and a spring stopper 64. Further, the relief valve 52 has a cylindrical passage 61 and an orifice 62, which will be described later in detail. The adjustment pipe 53 is fixed on an inner wall of the pump body 11. One end of the spring 54 is engaged with the relief valve 52, and the other end is engaged with the adjustment pipe 53. The relief valve 52 is biased toward a fourth valve seat 56 by the spring 54. A load of the spring 54 is adjusted by a press-insert amount of the adjustment pipe 53.

When the relief valve 52 sits on the fourth valve seat 56, the communication passage 51 is closed. When the relief valve 52 moves apart from the fourth valve seat 56, the communication passage 51 is opened.

An operation of the high-pressure pump 10 will be described hereinafter. The high-pressure pump 10 repeatedly performs the suction stroke, the metering stroke, and the pressurization stroke.

### (1) Suction Stroke

When the plunger 13 slides down from the top dead center toward the bottom dead center, the pressurization chamber 121 is depressurized. The coil 71 is deenergized, the suction valve 35 is opened, and the supply passage 100 is opened. The discharge valve 92 sits on the second valve seat 95 to close the discharge passage 114. Thus, the fuel in the damper chamber 201 is suctioned into the pressurization chamber 121 through the supply passage 100.

### (2) Metering Stroke

When the plunger 13 slides up from the bottom dead center toward the top dead center, the coil 71 is deenergized and the suction valve 35 is opened for a specified time period. Thus, the low-pressure fuel in the pressurization chamber 121 is returned to the damper chamber 201 through the supply passage 100.

In the metering stroke, when the coil 531 is energized at a specified time, a magnetic attraction force is generated between the fixed core 72 and the movable core 73. When the magnetic attracting force becomes larger than the biasing force of the spring 22, the movable core 73 and the needle 38 are attracted to the stationary core 46. The suction valve 35 and the needle 38 become apart from each other, and the suction valve 35 moves to the first valve seat 34. The suction valve 35 sits on the first valve seat 34 to close the supply passage 100.

When the supply passage 100 is closed, the metering stroke is terminated. That is, by adjusting the timing at which the coil 71 is energized, the low-pressure fuel quantity returned from the pressurization chamber 121 to the damper chamber 201 is adjusted. Thereby, the quantity of fuel pressurized in the pressurization chamber 121 is determined.

### (3) Pressurization Stroke

When the plunger 13 further slides up toward the top dead center with an interruption between the pressurization chamber 121 and the damper chamber 201, the fuel pressure in the pressurization chamber 121 further increases. When the fuel pressure in the pressurization chamber 121 exceeds a specified value, the discharge valve 92 is opened to discharge the pressurized fuel to outside of the high-pressure pump 10 through the discharge passage 114. The fuel discharged from the high-pressure pump 10 is accumulated in the delivery pipe 4 and is supplied to each fuel injector 5.

When the plunger 13 reaches the top dead center, the coil 71 is deenergized and the suction valve 35 is opened again. Then, the plunger slides down again to perform the suction stroke.

A feature configuration and operation of the constant residual pressure valve 60 will be described hereinafter.

As shown in FIG. 5, the valve body 69, the supporting member 68, the spring 65, and the spring stopper 64 are accommodated in an inner passage 57 defined in the relief valve 52. This inner passage 57 is a part of the communication passage 51. The valve body 69 is formed spherically. The valve 69 can sit on a third valve seat 63 which is formed in the inner passage 57. In the present embodiment, this third valve seat 63 corresponds to “valve seat” of the present invention. The supporting member 68 supports the valve body 69. An outer wall surface of the supporting member 68 is smoothed so that the fuel can flow around the supporting member 68.

The spring stopper 64 is press-inserted into the inner passage 57. The spring stopper 64 has an axial passage through which the fuel flows. One end of the spring 65 is engaged with the supporting member 68, and the other end is engaged with the spring stopper 64. The spring 65 biases the supporting member 68 and the valve body 69 toward the third valve seat 56. A load of the spring 65 is adjusted by the spring stopper 64.

During the pressurization stroke, the fuel pressure in the first communication passage 511 is substantially equal to the fuel pressure in the second communication passage 512. Thus, the valve body 69 sits on the third valve seat 65 by the spring 65 to close the inner passage 57.

Meanwhile, when the pressurization chamber 121 is depressurized in the suction stroke, the fuel pressure in the second communication passage 512 becomes lower than that in the first communication passage 511, which causes a differential pressure therebetween. The valve body 69 moves away from the third valve seat 63 to open the inner passage 57. The fuel flows through the communication passage 51 from the discharge passage 114 to the pressurization chamber 121.

Also when the high-pressure pump 10 is stopped, the differential pressure is generated so that the valve body 69 opens the inner passage 57. The fuel flows through the communication passage 51 from the discharge passage 114 to the pressurization passage 121.

As stated above, the relief valve 52 has the orifice 62 and the cylindrical passage 61.

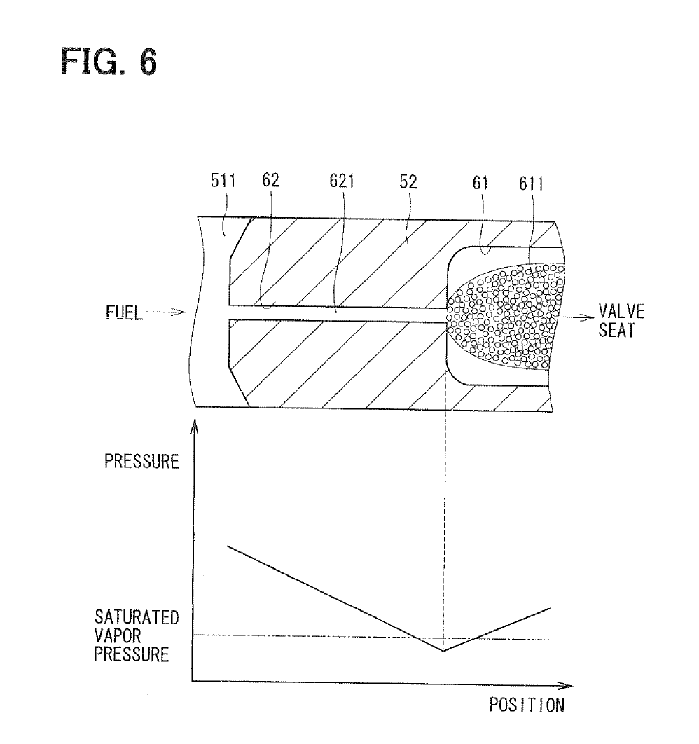

Referring to FIG. 6, a length of the orifice 62 and its function will be described.

When the fuel flows through the orifice passage 621 from the discharge passage 114 toward the third valve seat 63, its flow velocity is increased. Thus, during the suction stroke or the high-pressure pump stop period, the pressure of the fuel flowing through the orifice passage 621 is decreased lower than the saturated vapor pressure. A cross-sectional area and a length of the orifice passage 621 are determined so that the fuel pressure becomes lower than the saturated vapor pressure. When the fuel pressure in the orifice passage 621 becomes lower than the saturated vapor pressure, a cavitation is caused. Further, since the flow velocity of the fuel flowing into the cylindrical fuel passage 611 from the orifice passage 621 is high, a cavitation is caused around an outlet of the orifice 62. Fuel babbles generated in the orifice passage 621 flows into the cylindrical fuel passage 611.

Referring to FIG. 1, the cavitation in the orifice 62 will be described hereinafter.

An inner diameter of the cylindrical passage 61 is substantially constant from its inlet to an outlet and is defined so that the babbles generated by the cavitation do not adhere to an inner wall of the cylindrical passage 61. The babbles flow around the third valve seat 63 and the valve body 69. Then, the babbles are collapsed on the third valve seat 63 and the valve body 69, so that the foreign matters adhering to the third valve seat 63 and the valve body 69 are removed. Since a clearance between the third valve seat 63 and the valve body 69 is small, a cavitation is further caused therebetween. The babbles flow around the valve body 69 and the supporting member 68 and are collapsed thereon to remove the adhering foreign matters.

It should be noted that the relief valve 52, the third valve seat 63, the valve body 69 and the supporting member 68 has been received quenching processing. These are made of material of which hardness is high. Thereby, cavitation corrosions are restricted to the relief valve 52, the third valve seat 63, the valve body 69, and the supporting member 68.

An advantage of the constant residual pressure valve 60 will be described.

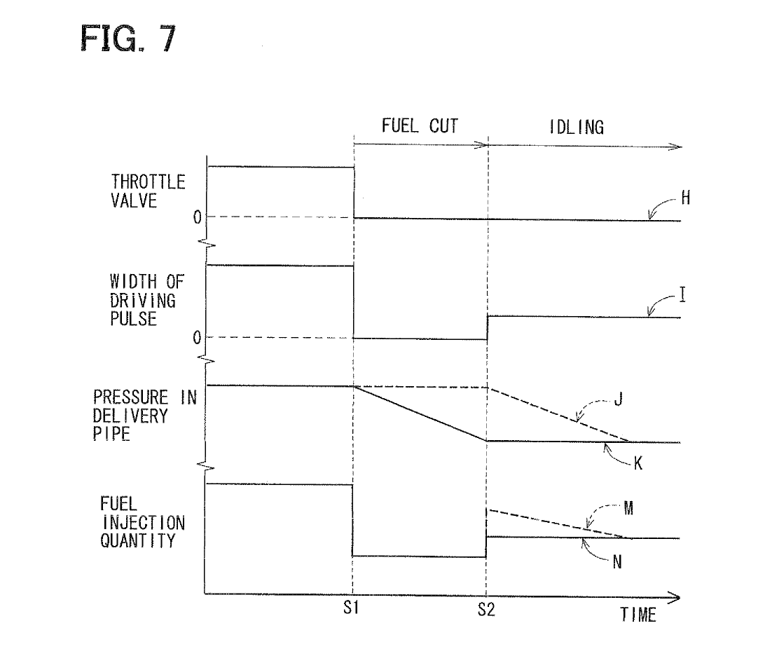

FIG. 7 is a time chart showing that the engine is at idling state after the accelerator pedal is released. As shown by a solid line “H”, when the accelerator pedal is released at a timing “S1”, an opening degree of a throttle valve becomes zero. At this time, as shown by a solid line “I”, when the engine speed is greater than or equal to a specified value, a width of driving pulse supplied to the fuel injector 5 becomes zero at a timing “S1” so that a fuel injection by the fuel injector 5 is stopped. Then, when the engine speed becomes less than the specified value at a timing “S2”, a driving pulse of which width is appropriate for an engine idling is transmitted to the fuel injector 5 so that the fuel injection is started again.

In a conventional fuel supply system having no constant residual pressure valve, as shown by a solid line “J”, since the fuel injection is not performed during a period from the timing “S1” to the timing “S2”, the fuel pressure in the delivery pipe is maintained as a pressure before the fuel injection is stopped. Thus, as shown by a dashed line “M”, even if the driving pulse width is made smaller to be appropriate for an engine idling at the time “S2”, it is likely that the fuel is injected by a quantity which is greater than a control target quantity.

Meanwhile, according to the present embodiment having the constant residual pressure valve 60, as shown by a solid line “K”, the fuel pressure in the delivery pipe 4 starts to decrease at the timing “S1”. Thus, as shown by a solid line “N”, the fuel injection quantity appropriate for an engine idling can be injected at the timing “S2”. A deterioration in fuel economy can be restricted and an excessive fuel injection can be avoided.

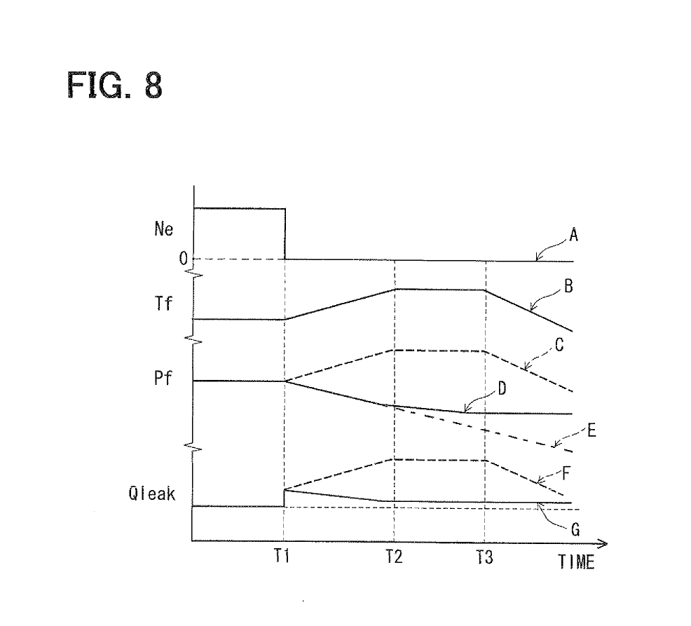

FIG. 8 is a time chart showing a condition where the engine is stopped. As shown by a solid line “A”, when the engine is stopped at a time “T1”, the engine speed NE becomes zero. An engine coolant does not circulate in the engine. As shown by a solid line “B”, a fuel temperature “Tf” in the delivery pipe 4 rises for a specified period “T1 to T2” and is maintained for a while “T2 to T3”. Then, the fuel temperature “Tf” drops after timing “T3”.

In the conventional fuel supply system having no constant residual pressure valve, as shown by a dashed line “C”, a fuel pressure “Pf” in the delivery pipe 4 also rises in a similar way of the fuel temperature “Tf” in the delivery pipe 4. Thus, as shown by a dashed line “F”, a fuel leakage quantity “Qleak” of the injector is increased. The leaked fuel may be discharged into atmosphere as unburned fuel.

Meanwhile, according to the present embodiment having the constant residual pressure valve 60, as shown by a solid line “D”, the fuel pressure “Pf” in the delivery pipe 4 starts to decrease right after the engine is stopped. Thus, as shown by a solid line “G”, the fuel leakage quantity “Qleak” is within a permissible value.

In a conventional constant residual pressure valve, foreign matters are accumulated on the third valve seat and the valve body, which deteriorates a valve-sealing and a pressure holding performance of the constant residual pressure valve. If such a high-pressure pump having a conventional constant residual pressure valve is applied to a fuel supply system, the fuel pressure “Pf” in the delivery pipe 4 continues to be decreased as shown by an alternate long and short dash line “E”. An evaporation temperature of fuel is also decreased. If the fuel temperature in the delivery pipe 4 exceeds the evaporation temperature, fuel vapor will be generated in the delivery pipe 4. Thereby, it is likely that a startability of the engine may be deteriorated. Further, if the valve body adheres to the third valve seat by the foreign matters, the fuel pressure “Pf” in the delivery pipe 4 is also increased. The fuel leakage quantity of the injector is also increased.

As described above, according to the present embodiment, a cavitation is generated in the orifice 62 and fuel babbles removes the foreign matters from the third valve seat 63, the valve body 69, and the supporting member 68. Thereby, a sealing performance between the valve body 69 and the third valve seat 69 can be improved and a pressure holding performance of the constant residual pressure valve 60 can be maintained. As shown by a solid line “K” in FIG. 7 and a solid line “D” in FIG. 8, the fuel pressure “Pf” in the delivery pipe 4 can be maintained substantially constant. As a result, in the delivery pipe 4, the constant residual pressure valve 60 can restrict an occurrence of fuel vapor to improve a startability of the engine.

### Second Embodiment

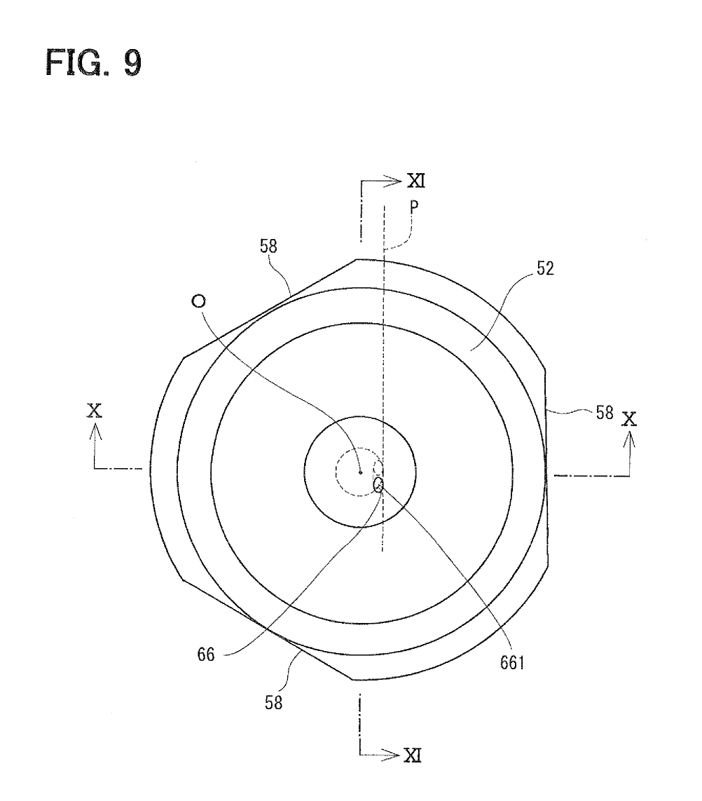

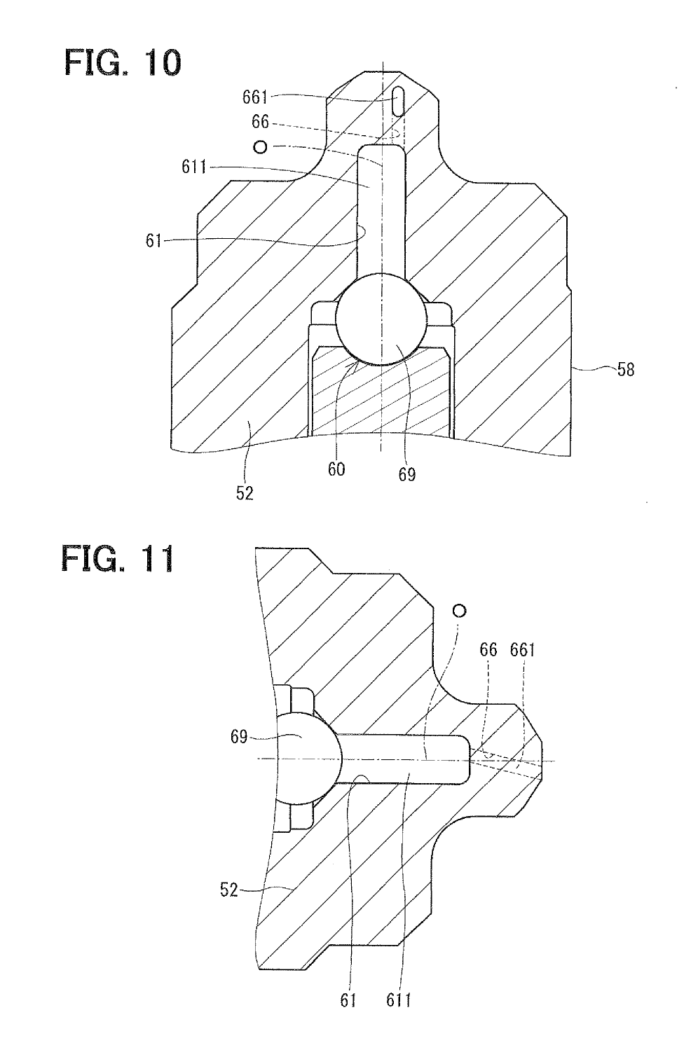

Referring to FIGS. 9 to 12, a second embodiment of the invention will be described. As shown in FIG. 9, the relief valve 52 is provided with three chamfers 58 to allow a radial fuel flow.

The orifice passage 661 is inclined and offset relative to a center line “O” of the cylindrical passage 61. Furthermore, the orifice passage 661 is formed in approximately parallel to a virtual plane “P” which is adjacent to the peripheral edge of the cylindrical fuel passage 611.

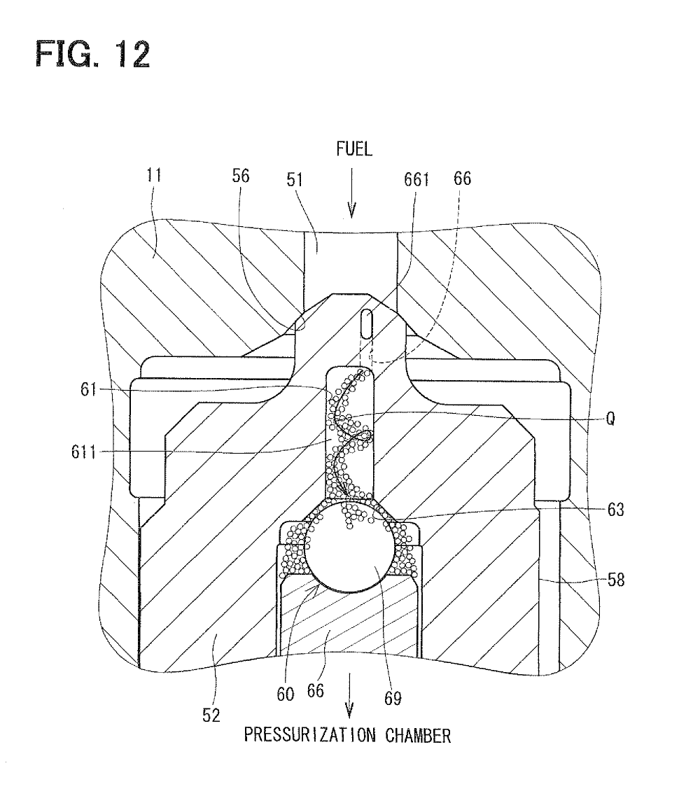

As shown in FIG. 12, the fuel discharged from the orifice passage 661 flows along an inner wall of the cylindrical fuel passage 611 and generates a swirl flow as shown by an arrow “Q”. The babbles flows along with the swirl flow to reach the third valve seat 63 and the valve body 69. When these babbles are collapsed, the foreign matters accumulated on the third valve seat 63 and the valve body 69 are removed.

Thereby, a sealing performance between the valve body 69 and the third valve seat 69 can be improved and a pressure holding performance of the constant residual pressure valve 60 can be maintained. As a result, in the delivery pipe 4, the constant residual pressure valve 60 can restrict an occurrence of fuel vapor to improve a startability of the engine.

### Third Embodiment

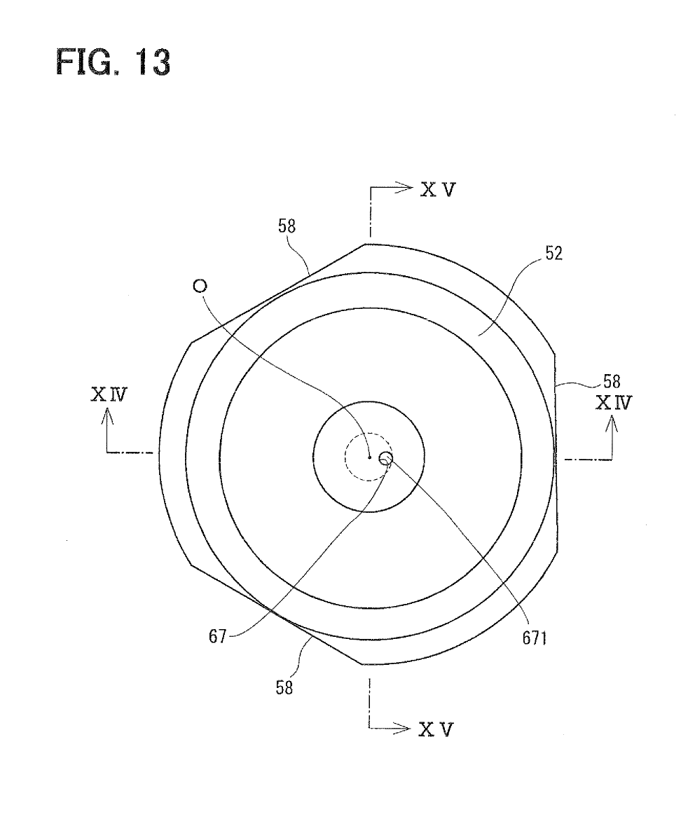

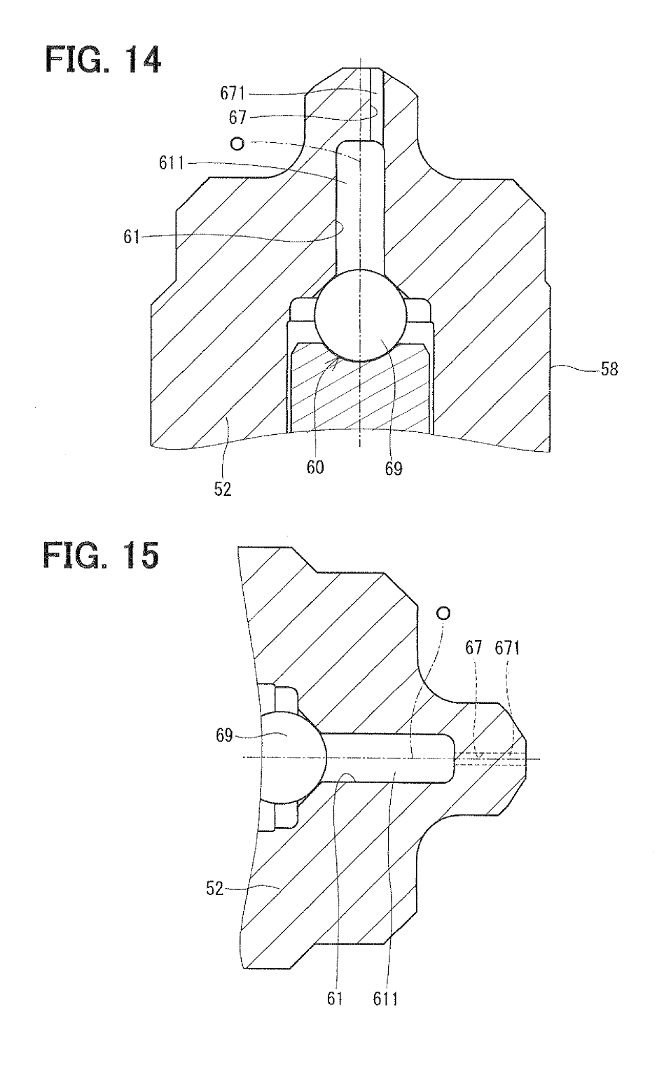

Referring to FIGS. 13 to 15, a third embodiment of the invention will be described.

As shown in FIG. 13, the relief valve 52 is provided with three chamfers 58 to allow a radial fuel flow. An orifice passage 671 of an orifice 67 is formed in parallel to the center line “O” of the cylindrical passage 61. Further, the orifice passage 671 is formed in such a manner as to deviate from the center line “O”. The babbles flow through the cylindrical fuel passage 611 toward the third valve seat 63. When these babbles are collapsed, the foreign matters accumulated on the third valve seat 63 and the valve body 69 are removed.

In this embodiment, since the dynamic pressure of the fuel flowing through the cylindrical fuel passage 611 acts on the valve body 69 eccentrically, the valve body 69 rotates. Thus, the babble collapse impact can act on the whole surface of a sphere valve body 69. The foreign matters can be easily removed from the third valve seat 63, the valve body 69, and the supporting member 68. As a result, in the delivery pipe 4, the constant residual pressure valve 60 can restrict an occurrence of fuel vapor to improve a startability of the engine.

### Fourth Embodiment

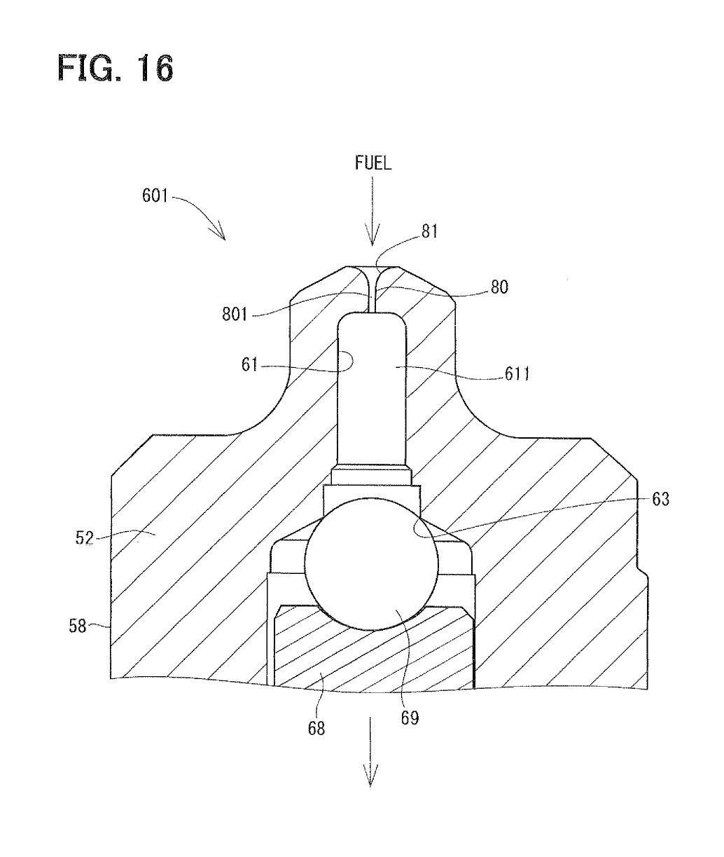

Referring to FIG. 16, a fourth embodiment of the invention will be described.

In the fourth embodiment, an inlet portion 81 of an orifice 80 has larger diameter. The fuel flows into the orifice passage 801 along an inner wall surface of the inlet portion 81. Since the flow resistance of the inlet portion 81 of the orifice 80 is decreased, the flow velocity of the fuel flowing through the orifice passage 801 is increased, and the fuel pressure is decreased. When the fuel pressure flowing out from the orifice 80 becomes lower than the saturated vapor pressure, a cavitation is caused, which generates a large amount of babbles. The babbles flow through the cylindrical fuel passage 611 toward the third valve seat 63 and the valve body 69. When these babbles are collapsed, the foreign matters accumulated on the third valve seat 63 and the valve body 69 are removed. Thereby, a sealing performance between the valve body 69 and the third valve seat 69 can be improved and a pressure holding performance of the constant residual pressure valve 601 can be maintained.

### Fifth Embodiment

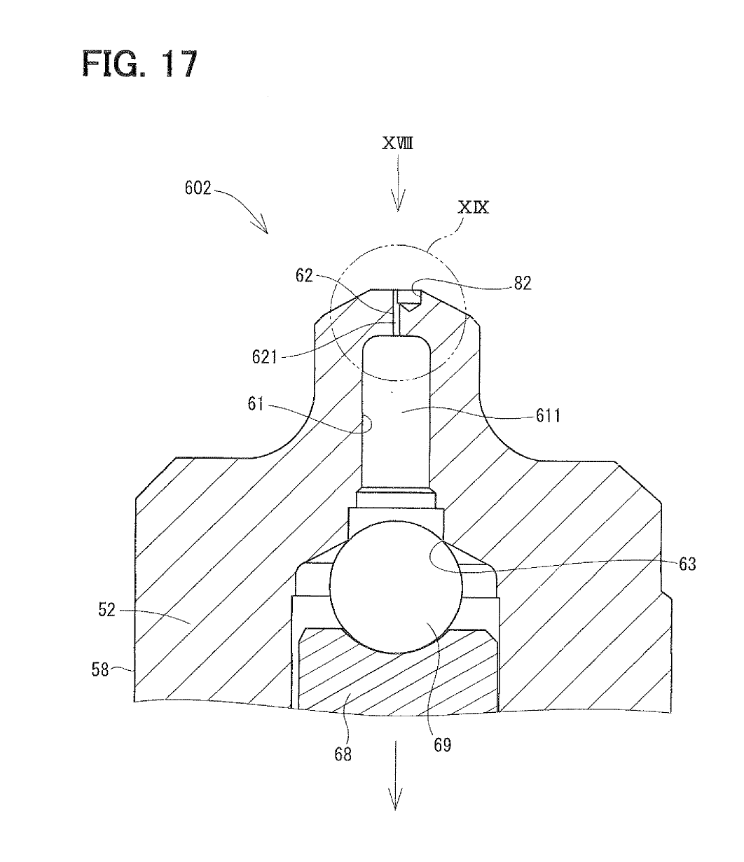

Referring to FIGS. 17 to 19, a fifth embodiment of the invention will be described.

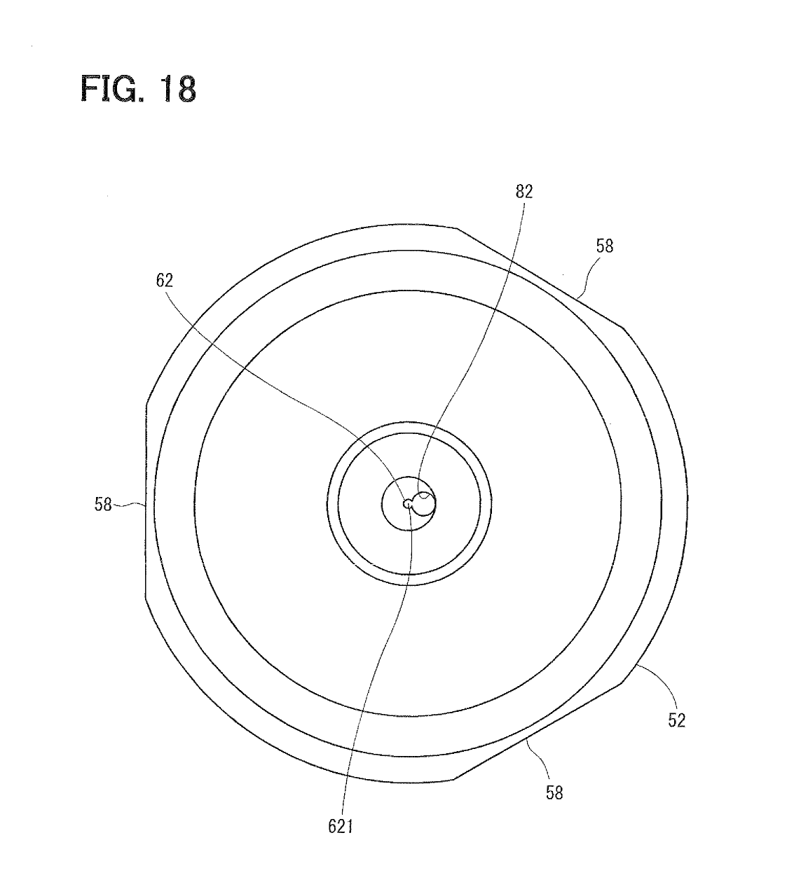

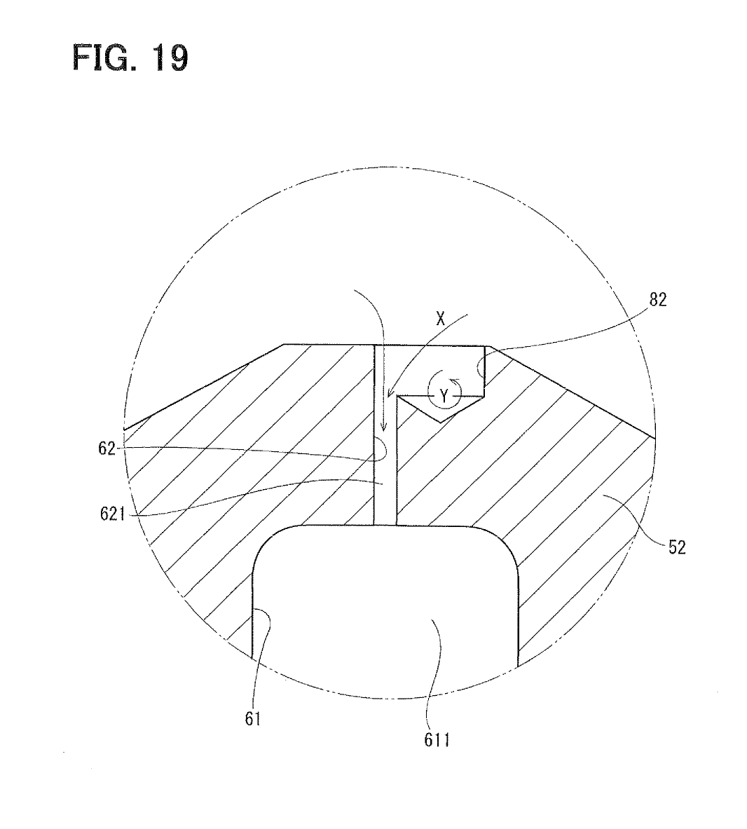

As shown in FIG. 18, the relief valve 52 is provided with three chamfers 58 to allow a radial fuel flow. A step hole 82 is provided to the relief valve 52 adjacent to the orifice 62. A center axis of the step hole 82 deviates from a center axis of the orifice passage 621. The step hole 82 communicates with the orifice passage 621 in its radial direction. As shown in FIG. 19, the fuel flows into the orifice passage 621 through the step hole 82 as shown by an arrow “X”. Its flow velocity is relatively high. Thus, as shown by an arrow “Y”, a negative pressure is generated at a vicinity of a bottom of the step hole 82. When the fuel pressure in the step hole 82 becomes less than the saturated vapor pressure, babbles are generated in the step hole 82. These babbles are introduced into the orifice passage 621. Then, a large amount of babbles are discharged from the orifice 62. These babbles remove the accumulated foreign matters.

### Sixth Embodiment

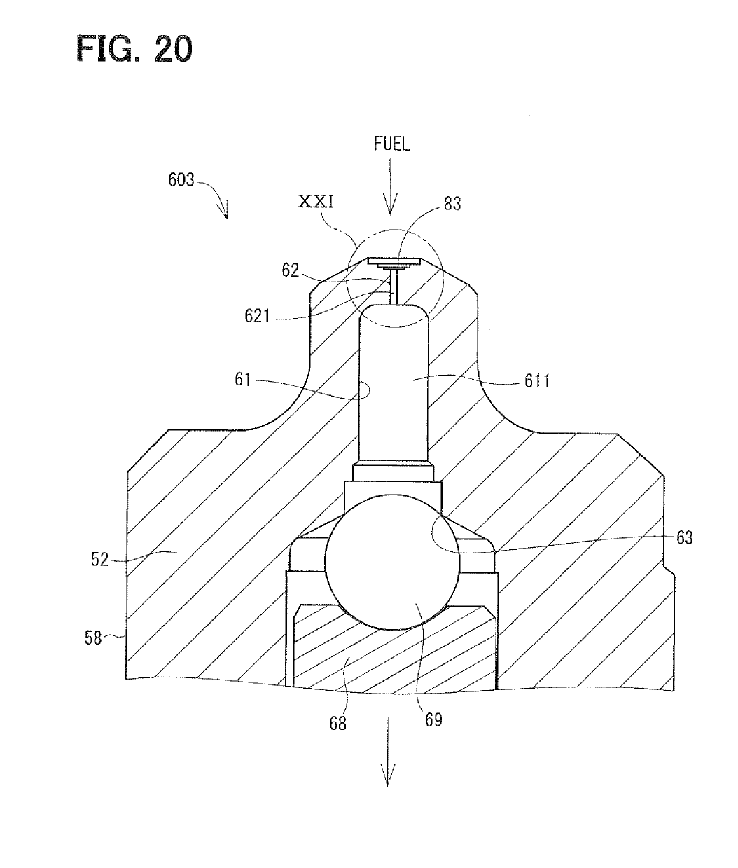

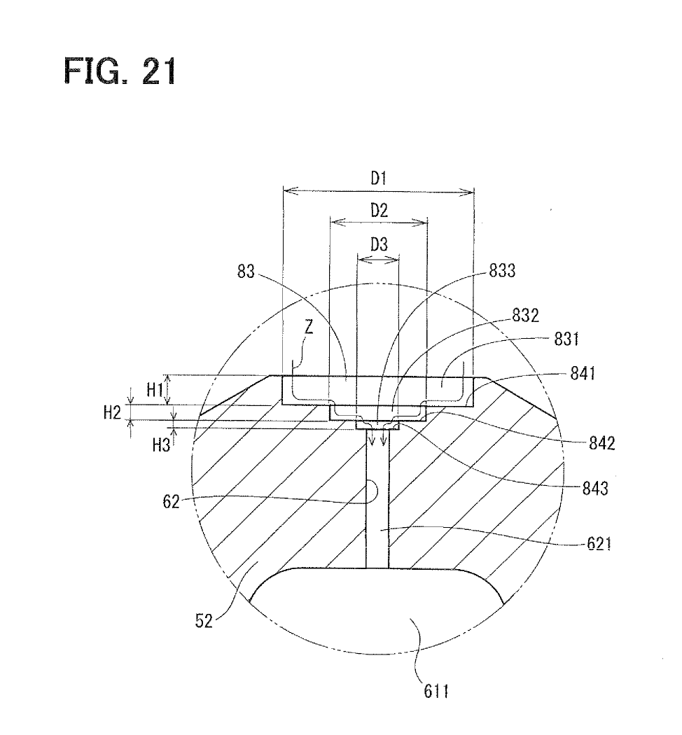

Referring to FIGS. 20 and 21, a sixth embodiment of the invention will be described.

A cylindrical concaved portion 83 is provided to an end of the orifice 62. This concave portion 83 is comprised of a plurality of concaves which are coaxially formed relative to the orifice passage 621. Specifically, the concave portions 83 is comprised a first to third concave portions 831-833. An inner diameter “D2” of the second concave portion 832 is about ½ of an inner diameter “D1” of the first concave portion 831. An inner diameter “D3” of the third concave portion 833 is about ½ of the inner diameter “D2”. A first step portion 841 is formed between the first concave portion 831 and the second concave portion 832. A second step portion 842 is formed between the second concave portion 832 and the third concave portion 833. A third step portion 843 is formed between the third concave portion 833 and the orifice passage 621.

A depth “H2” of the second concave portion 832 is about ½ of a depth “H1” of the first concave portion 831. A depth “H3” of the third concave portion 833 is about ½ of the depth “H2” of the second concave portion 832.

As shown by an arrow “Z” in FIG. 21, the fuel flowing into the first concave portion 831 collides with the first step portion 841, and then its flowing direction is changed to a vertical direction relative to the center axis of the orifice passage 621. The fuel flowing into the second concave portion 832 from the first concave portion 831 collides with the second step portion 842 to change its flowing direction vertically relative to the center axis of the orifice passage 621. Then, the fuel flowing into the third concave portion 833 from the second concave portion 832 collides with the third step portion 843 to change its flowing direction vertically relative to the center axis of the orifice passage 621. As above, the flow direction of the fuel is changed multiple times, so that its flow velocity is decreased. A pressure drop of the fuel is restricted and the quantity of babbles due to the cavitation is also decreased. A noise and vibration due to the cavitation can be reduced.

According to the present embodiment, since the cavitation is restricted, the cavitation corrosion is also restricted. The number of the concave portion 831-833 is not limited to three.

### Seventh Embodiment

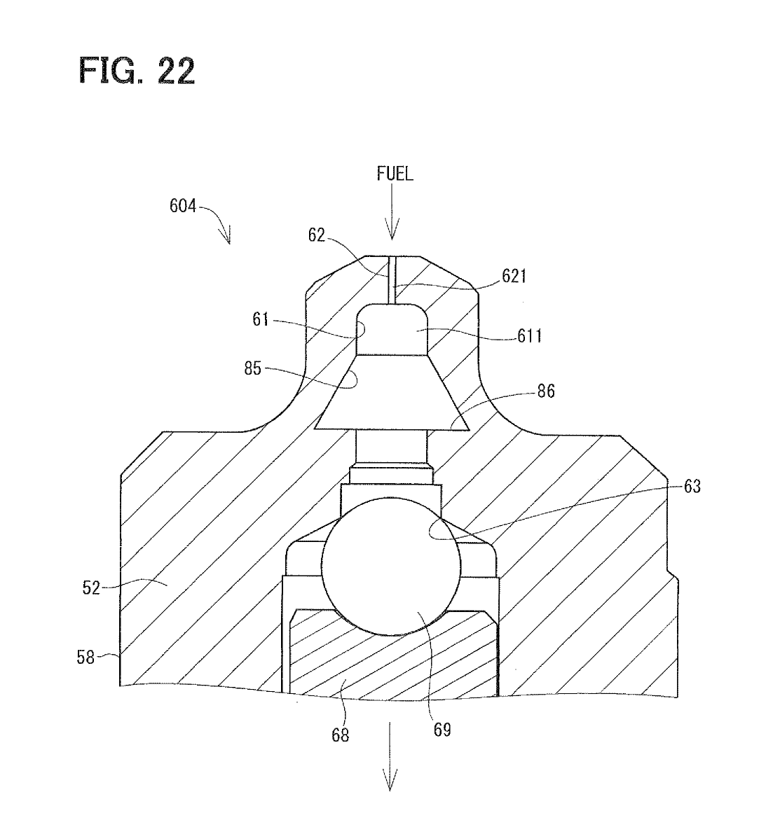

Referring to FIG. 22, a seventh embodiment of the invention will be described.

The cylindrical passage 61 includes a taper portion 85. The taper portion 85 forms a step surface 86. The fuel flowing into the cylindrical passage 61 collides with the step surface 86 and its flowing direction is changed vertically relative to the center axis of the orifice passage 621, so that its flow velocity is decreased. The pressure drop of the fuel is restricted and the quantity of babbles due to the cavitation is also decreased, so that the cavitation corrosion is restricted. Further, the noise and the vibration due to the cavitation can be reduced.

### Eighth Embodiment

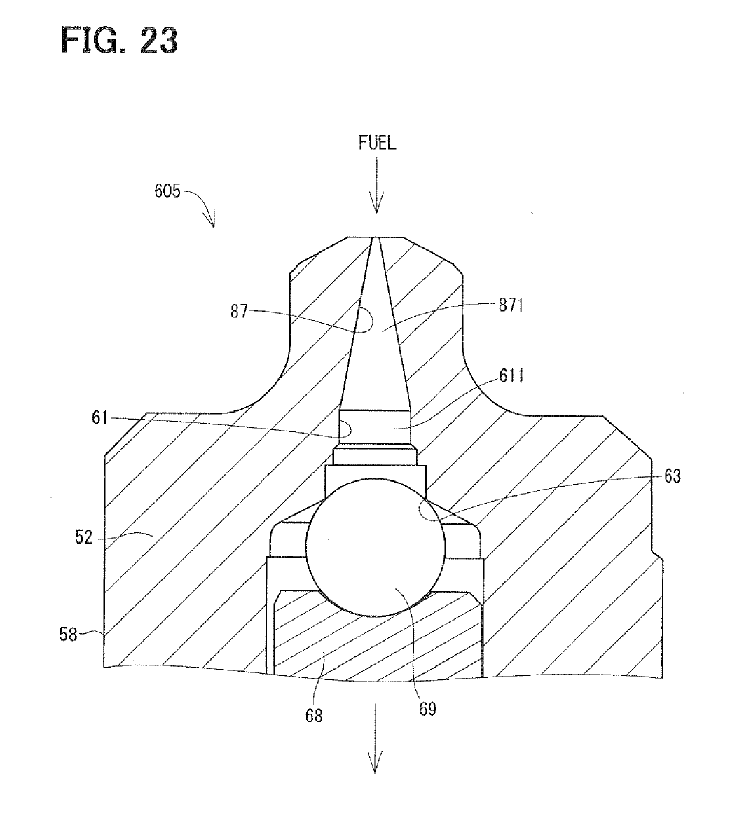

Referring to FIG. 23, an eighth embodiment of the invention will be described.

An orifice passage 871 has a tapered shape. The inner diameter of the orifice passage 871 is gradually increased in a fuel flow direction. The flow velocity of the fuel flowing through the orifice passage 871 becomes lower. Thus, a cavitation in the orifice passage 871 is restricted and a quantity of babble flowing to the valve seat 63 and the valve body 69 is decreased, so that the cavitation corrosion is also restricted. Further, a noise and a vibration due to the cavitation can be reduced.

### Ninth Embodiment

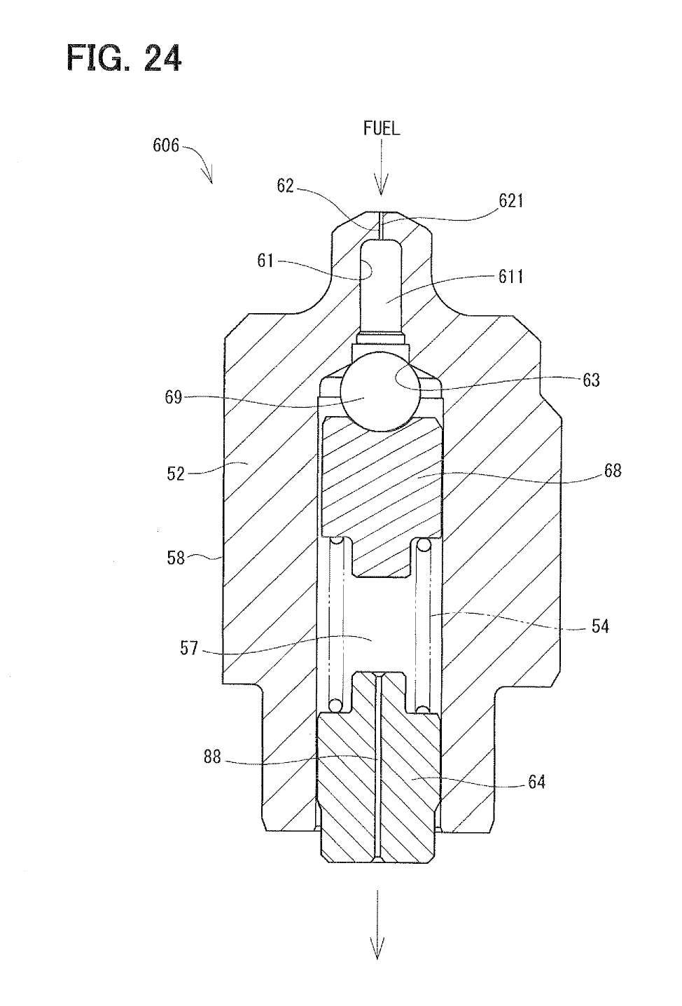

Referring to FIG. 24, a ninth embodiment of the invention will be described. The relief valve 52 has a first orifice 62 and the spring stopper 64 has a second orifice 88. An inner diameter of the second orifice 88 is greater than that of the first orifice 62. Since the second orifice 88 is provided, a differential pressure between upstream and downstream of the first orifice 62 becomes smaller. Thus, the flow velocity of the fuel flowing through the first orifice 62 is decreased. A pressure drop of the fuel is restricted and the quantity of babbles due to the cavitation is also decreased.

In the present embodiment, by adjusting a difference between the inner diameter of the first orifice 62 and the inner diameter of the second orifice 88, the differential pressure at the first orifice 62 can be controlled. The flow velocity of the fuel flowing through the first orifice 62 can be decreased to control the cavitation.

### Tenth Embodiment

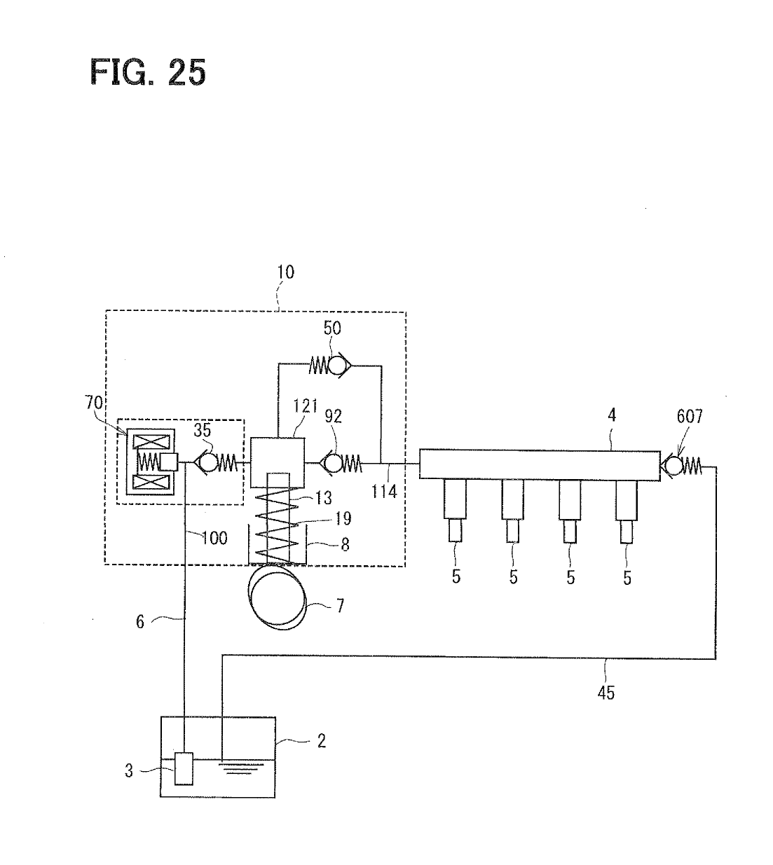

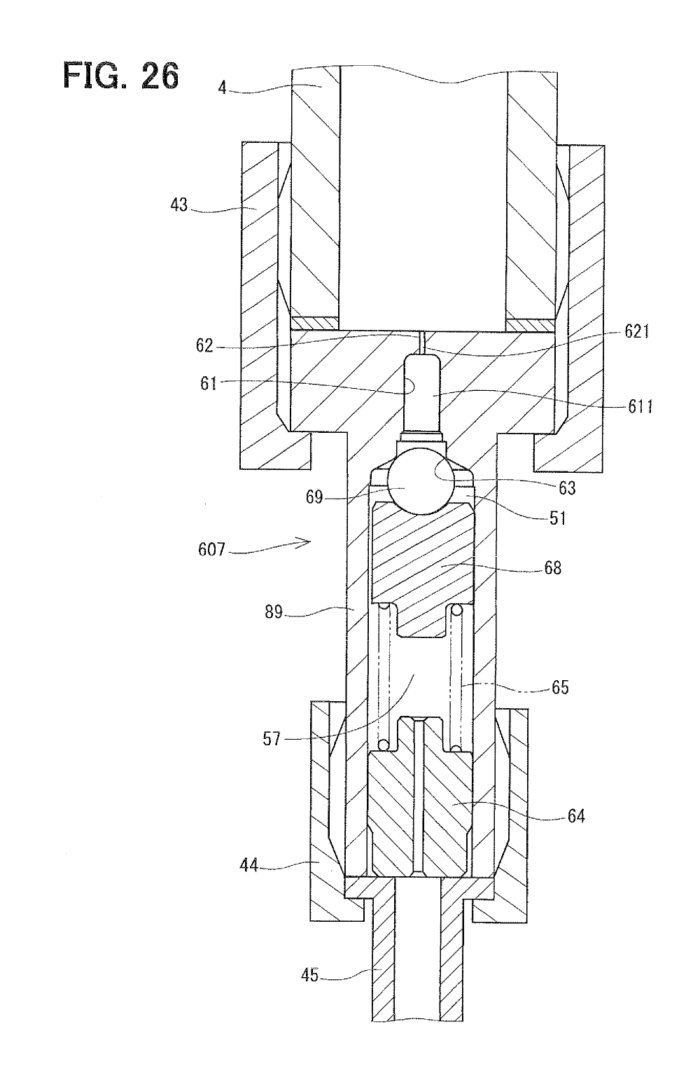

Referring to FIGS. 25 and 26, a tenth embodiment of the invention will be described.

In the tenth embodiment, the constant residual pressure valve 607 is provided to an end portion of the delivery pipe 4. The return pipe 45 hydraulically connects the constant residual pressure valve 607 and the fuel tank 2. The constant residual pressure valve 607 has a housing 89 which defines a communication passage 51. The valve body 69, the supporting member 68, the spring 65, and the spring stopper 64 are accommodated in the communication passage 51. The housing 89 is provided with the orifice 62, the cylindrical passage 61, and the valve seat 63. One end of the housing 89 is connected to the delivery pipe 4 by a first nut 43 and the other end is connected to the return pipe 45 by a second nut 44.

Also in this embodiment, a cavitation is caused in the orifice 62. The babbles flow through the cylindrical fuel passage 611 toward the third valve seat 63 and the valve body 69. When these babbles are collapsed, the foreign matters accumulated on the third valve seat 63 and the valve body 69 are removed. Thereby, a sealing performance between the valve body 69 and the third valve seat 69 can be improved and a pressure holding performance of the constant residual pressure valve 607 can be maintained.

### Eleventh Embodiment

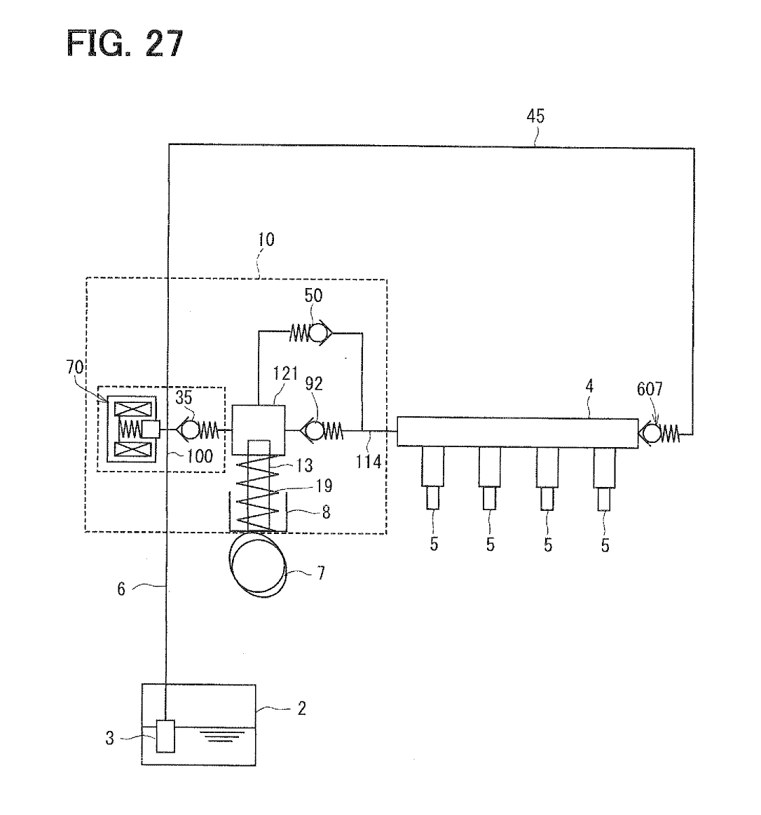

Referring to FIG. 27, an eleventh embodiment of the invention will be described. In the eleventh embodiment, the constant residual pressure valve 607 is provided to an end portion of the delivery pipe 4. One end of the return pipe 45 is connected to the constant residual pressure valve 607 and the other end is connected to a supply passage 100 of the high-pressure pump. Also in this embodiment, a cavitation is caused in the orifice 62. The other end of the return pipe 45 may be connected to a low-pressure fuel pipe 6 which connects the high-pressure pump 10 and the fuel tank 2.

### Twelfth Embodiment

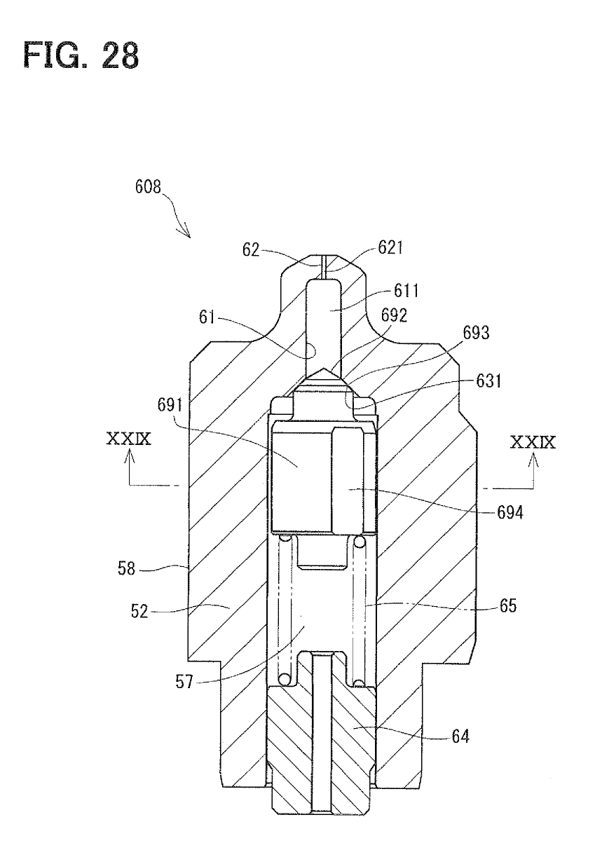

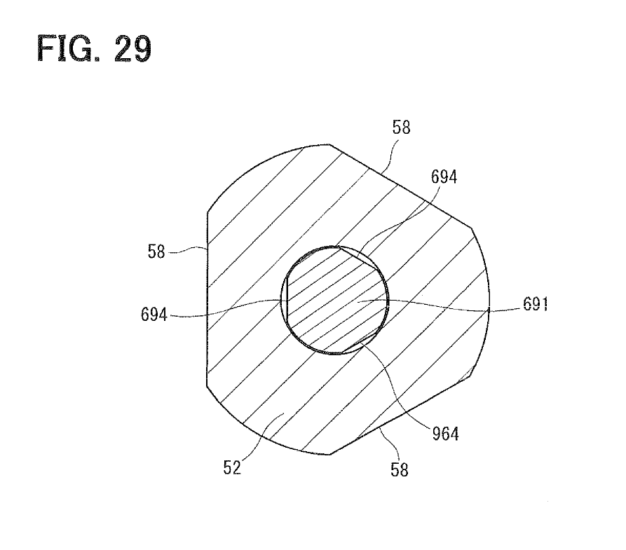

Referring to FIGS. 28 and 29, a twelfth embodiment of the invention will be described. In the twelfth embodiment, the valve body is a needle valve 691. The needle valve 691 has three fiat surface 694 on its outer surface through which the fuel flows. As shown in FIG. 29, the relief valve 52 is provided with three chamfers 58 to allow a radial fuel flow.

### Other Embodiment

The constant residual pressure valve can be arranged in a passage which is defined in the discharge valve 92. In this case, the passage in the discharge valve 92 corresponds to a communication passage. Alternatively, the communication passage is defined in the pump body and the constant residual pressure valve can be arranged in this communication passage.

The present invention is not limited to the embodiments mentioned above, and can be applied to various embodiments by combining each embodiment.

What is claimed is:

1. A constant residual pressure valve controlling a fuel flow between a high-pressure passage and a low-pressure passage, comprising:
a valve body opening/closing a communication passage in cooperation with a valve seat which is formed on an inner surface of the communication passage, the communication passage hydraulically connecting the high-pressure passage and the low-pressure passage;
an orifice provided in the communication passage upstream of the valve seat; and
a cylindrical passage arranged between the orifice and the valve seat in such a manner as to introduce a cavitation bubble toward the valve seat, the cavitation bubble being generated in the fuel discharged from the orifice.

2. A constant residual pressure valve according to claim 1, wherein
the orifice reduces a pressure of fuel flowing from the high-pressure passage to the low-pressure passage therethrough so that the pressure of fuel becomes lower than a saturated vapor pressure.

3. A constant residual pressure valve according to claim 1, wherein
the orifice has a specified flow passage area so that a pressure in a delivery pipe is increased by a high-pressure pump without any influence.

4. A constant residual pressure valve according to claim 1, wherein
the orifice defines an orifice passage which is inclined relative to a center line “O” of the cylindrical passage, whereby the fuel flowing through the cylindrical passage generates a swirl flow.

5. A constant residual pressure valve according to claim 1, wherein
the orifice defines an orifice passage which is offset relative to a center line “O” of the cylindrical passage.

6. A constant residual pressure valve according to claim 1, wherein
the orifice has an inlet portion of which inner diameter is gradually increased toward its opening end.

7. A constant residual pressure valve according to claim 1, further comprising
a step hole which is provided adjacent to an opening end of the orifice, wherein
the step hole and the orifice are hydraulically connected with each other in a radial direction so that a negative pressure is generated in the fuel flowing into the orifice from the step hole.

8. A constant residual pressure valve according to claim 1, wherein
the orifice has a plurality of concave portions at its opening end, and
the concave portions define a plurality of step portions therebetween, which reduce a flow velocity of the fuel.

9. A constant residual pressure valve according to claim 1, wherein
the cylindrical passage includes a taper portion and a step surface which is vertical relative to a center axis of the cylindrical passage.

10. A constant residual pressure valve according to claim 1, wherein
the orifice is tapered in such a manner that an inner diameter of the orifice increases along a fuel flow direction.

11. A constant residual pressure valve according to claim 1, further comprising:
a spring biasing the valve body toward the valve seat;
a spring stopper provided in the communication passage; and
a second orifice defined in the spring stopper, wherein
an inner diameter of the second orifice is larger than that of the orifice.

12. A constant residual pressure valve according to claim 1, wherein
the cylindrical passage has a flow passage area and a length so as to introduce the cavitation bubble generated by the orifice to the valve seat and the valve body.

13. A constant residual pressure valve according to claim 1, wherein
the valve body and the valve seat are processed to improve a surface hardness thereof.
